(19) United States
(12) Patent Application Publication
(10) Pub. No.: US 2026/0254811 A1
(43) Pub. Date: Aug. 27, 2026

(54) SERVER APPARATUS, CONTROL METHOD OF SERVER APPARATUS, AND STORAGE MEDIUM

(71) Applicant: NEC Corporation, Tokyo (JP)

(72) Inventor: Takatoshi OSU, Tokyo (JP)

(73) Assignee: NEC Corporation, Tokyo (JP)

(21) Appl. No.: 19/489,737

(22) PCT Filed: Jun. 28, 2023
(86) PCT No.: PCT/JP2023/023987

§ 371 Date: Dec. 3, 2025

(51) Int. Cl. H04L 9/40

(52) U.S. Cl. CPC H04L 63/0861

(57) ABSTRACT

A server apparatus includes storage means and ID linkage control means. The storage unit stores, for a plurality of users, biometric information and individual IDs, the individual IDs being IDs for each of a plurality of service providers each of which provide services using biometric authentication, in a database in association with each other. The ID linkage control means acquires, from a first service provider, biometric information of a first user and a first individual ID used by the first service provider for managing the first user. The ID linkage control means performs matching processing using the acquired biometric information of the first user and biometric information stored in the database. In a case where matching processing succeeds, the ID linkage control unit stores the first user's biometric information and the first individual ID in association with each other in an entry of the database identified by the matching processing.

### TECHNICAL FIELD

The present invention relates to a server apparatus, a control method of a server apparatus, and a storage medium.

### BACKGROUND ART

There exists a technique for associating information of the same individual among different business operators.

For example, Patent Literature 1 describes that even if data of the same individual are not associated in advance among different business operators, a linkage server program and the like capable of associating anonymized data of the same individual can be provided. The linkage server program described in Patent Literature 1 implements a linkage acquisition unit, a combination unit, and a linkage provision unit. The linkage acquisition unit acquires anonymized customer data, which is anonymized customer data managed by each of a plurality of business operator servers, and hash data from the plurality of business operator servers. The hash data represent a hash value calculated based on data of a key data item of customer data that serve as a key for combining the customer data managed by the respective plurality of business operator servers. The combination unit combines the anonymized customer data respectively acquired from the plurality of business operator servers by using the hash values respectively acquired from the plurality of business operator servers as keys, thereby generating combined anonymized customer data. The linkage provision unit provides the combined anonymized customer data to at least one of a business operator server and another external apparatus.

### CITATION LIST

### Patent Literature

[PTL 1] Japanese Unexamined Patent Application Publication No. JP2021-117679

### SUMMARY OF INVENTION

### Technical Problem

As disclosed in Patent Literature 1, there is a need to associate and utilize information (data) of the same user held by different business operators. For example, service providers such as hotels and restaurants manage customers by using their own IDs. Since unique IDs are used in each service provider, it is difficult to accurately perform matching of information (data) held by each service provider. Specifically, due to variations in notation, matching based on names or addresses has a problem with accuracy.

It is a main object of the present invention to provide a server apparatus, a control method of a server apparatus, and a storage medium that contribute to enabling utilization of user information held by different business operators.

### Solution to Problem

According to a first aspect of the present invention, there is provided a server apparatus including: a storage means that stores, for a plurality of users, biometric information and individual IDs, the individual IDs being IDs for each of a plurality of service providers each of which provide services using biometric authentication, in a database in association with each other; and an ID linkage control means that acquires, from a first service provider, biometric information of a first user and a first individual ID used by the first service provider for managing the first user, and stores, in a case where matching processing using the acquired biometric information of the first user and the biometric information stored in the database succeeds, the biometric information of the first user and the first individual ID in association with each other in an entry of the database identified by the matching processing.

According to a second aspect of the present invention, there is provided a control method of a server apparatus, the control method including: a storage step that stores, for a plurality of users, biometric information and individual IDs, the individual IDs being IDs for each of a plurality of service providers each of which provide services using biometric authentication, in a database in association with each other; and an ID linkage control step that acquires, from a first service provider, biometric information of a first user and a first individual ID used by the first service provider for managing the first user, and stores, in a case where matching processing using the acquired biometric information of the first user and the biometric information stored in the database succeeds, the biometric information of the first user and the first individual ID in association with each other in an entry of the database identified by the matching processing.

According to a third aspect of the present invention, there is provided a computer-readable storage medium storing a program causing a computer mounted on a server apparatus to perform processing for: a storage processing that stores, for a plurality of users, biometric information and individual IDs, the individual IDs being IDs for each of a plurality of service providers each of which provide services using biometric authentication, in a database in association with each other; and an ID linkage control processing that acquires, from a first service provider, biometric information of a first user and a first individual ID used by the first service provider for managing the first user, and stores, in a case where matching processing using the acquired biometric information of the first user and the biometric information stored in the database succeeds, the biometric information of the first user and the first individual ID in association with each other in an entry of the database identified by the matching processing.

### Advantageous Effects of Invention

The individual aspects of the present invention provide a server apparatus, a control method of a server apparatus, and a storage medium that contribute to enabling utilization of user information held by different business operators are provided. It should be noted that the advantageous effect of the present invention is not limited to the above advantageous effect. The present invention may provide other advantageous effects, instead of or in addition to the above advantageous effect.

### BRIEF DESCRIPTION OF THE DRAWINGS

FIG. 1 is a diagram illustrating an outline of an example embodiment.

FIG. 2 is a flowchart illustrating an example of an operation of an example embodiment.

FIG. 3 is a diagram illustrating an example of a schematic configuration of an information processing system according to a first example embodiment.

FIG. 4 is a diagram for explaining an operation of the information processing system according to the first example embodiment.

FIG. 5 is a diagram for explaining an operation of the information processing system according to the first example embodiment.

FIG. 6 is a diagram for explaining an operation of the information processing system according to the first example embodiment.

FIG. 7 is a diagram for explaining an operation of the information processing system according to the first example embodiment.

FIG. 8 is a diagram illustrating an example of a processing configuration of a control server according to the first example embodiment.

FIG. 9 is a flowchart illustrating an example of an operation of an ID linkage control unit according to the first example embodiment.

FIG. 10 is a diagram illustrating an example of a user management database according to the first example embodiment.

FIG. 11 is a diagram illustrating an example of a display of a terminal according to the first example embodiment.

FIG. 12 is a diagram illustrating an example of a processing configuration of a service server according to the first example embodiment.

FIG. 13 is a diagram illustrating an example of a customer management database according to the first example embodiment.

FIG. 14 is a flowchart illustrating an example of operation of an authentication control unit according to the first example embodiment.

FIG. 15 is a diagram illustrating an example of a processing configuration of an authentication terminal according to the first example embodiment.

FIG. 16 is a sequence diagram illustrating an example of an operation of the information processing system according to the first example embodiment.

FIG. 17 is a diagram illustrating an example of a display of the terminal according to a variation of the first example embodiment.

FIG. 18 is a diagram for explaining an operation of the information processing system according to a second example embodiment.

FIG. 19 is a diagram illustrating an example of the user management database according to the second example embodiment.

FIG. 20 is a diagram illustrating an example of a user management database according to a variation of the second example embodiment.

FIG. 21 is a diagram illustrating an example of a hardware configuration of a control server according to the present disclosure.

### EXAMPLE EMBODIMENT

First, an outline of an example embodiment will be described. It should be noted that, in the following outline, various components are denoted by reference characters for the sake of convenience. That is, the following reference characters are used as examples to facilitate the understanding of the present invention. Thus, the description of the outline is not intended to impose any limitations. In addition, unless otherwise specified, an individual block illustrated in the drawings represents a configuration of a functional unit, not a hardware unit. An individual connection line between blocks in the drawings signifies both one-way and two-way directions. An arrow schematically illustrates a principal signal (data) flow and does not exclude bidirectionality. In the present description and drawings, elements that can be described in a like way will be denoted by a like reference character, and redundant description thereof will be omitted as needed.

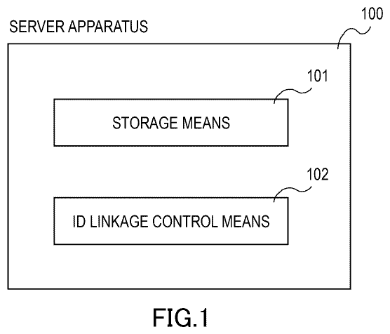

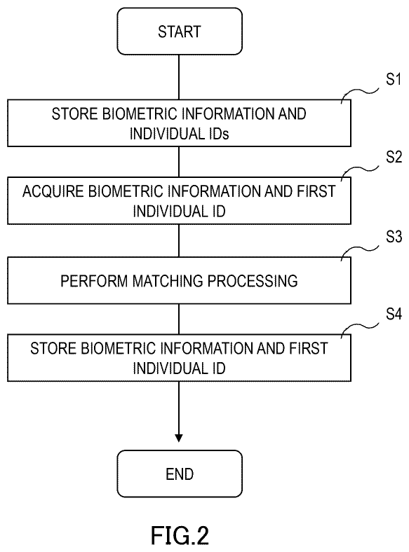

A server apparatus 100 according to an example embodiment includes a storage means 101 and an ID linkage control means 102 (see FIG. 1). The storage means 101 stores, for a plurality of users, biometric information and individual IDs, the individual IDs being IDs for each of a plurality of service providers each of which provide services using biometric authentication, in a database in association with each other (storage of biometric information and individual IDs; step S1 in FIG. 2). The ID linkage control means 102 acquires, from a first service provider, biometric information of a first user and a first individual ID used by the first service provider for managing the first user (step S2). The ID linkage control means 102 performs matching processing using the acquired biometric information of the first user and biometric information stored in the database (step S3). In a case where matching processing succeeds, the ID linkage control means 102 stores the first user's biometric information and the first individual ID in association with each other in an entry of the database identified by the matching processing (step S4).

In a case where the server apparatus 100 acquires, from a service provider, an individual ID used by the service provider to manage a user, the server apparatus 100 identifies a user registered in the database by using biometric information of the user. The server apparatus 100 stores the acquired individual ID in the entry of the identified user. That is, the server apparatus 100 performs matching (association) of individual IDs respectively used by different service providers by using biometric information of the user. Biometric information has characteristics such as universality in that all people possess it, uniqueness in that it differs from person to person, and permanence in that it remains unchanged throughout life. Accordingly, the server apparatus 100 can accurately perform association of individual IDs, unlike matching using names or the like. In addition, in a case where individual IDs of different service providers (business operators) are associated with each other, the server apparatus 100 can request provision of behavior histories while providing individual IDs to respective service providers. The server apparatus 100 can provide more useful information to business operators who wish to understand user consumption behaviors by integrating behavior histories held by respective service providers. That is, the server apparatus 100 enables utilization of user information held by different business operators.

Hereinafter, specific example embodiments will be described in more detail with reference to drawings.

### First Example Embodiment

A first example embodiment will be described in more detail with reference to drawings.

### System Configuration

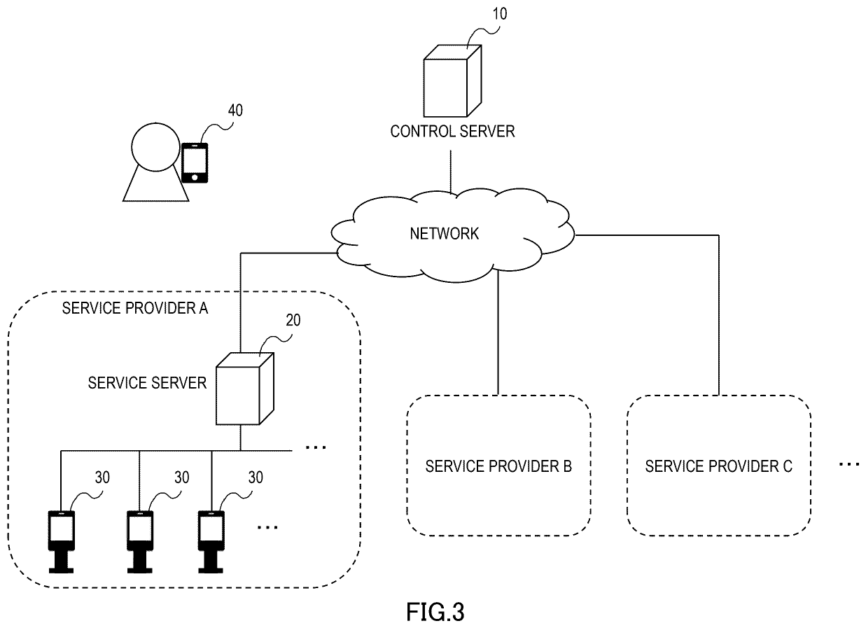

FIG. 3 is a diagram illustrating an example of a schematic configuration of an information processing system (information provision system, authentication system) according to the first example embodiment. As illustrated in FIG. 3, the information processing system includes a plurality of service providers A to C.

A service provider is a business operator that provides a service to a user by using biometric authentication. The information processing system according to the present disclosure assumes that service providers belonging to various types of businesses and industries provide services by using biometric authentication. It should be noted that the services provided by the service providers may be either paid or free of charge.

For example, business operators that provide accommodation services, business operators such as retail stores or restaurants, business operators that provide financial services, and educational business operators are exemplified as service providers. Alternatively, business operators that provide rental housing services such as condominiums, business operators that are workplaces of employees (user workplaces), business operators that hold events such as concerts, and business operators that operate transportation means such as aircraft are also included as service providers of the present disclosure. It should be noted that the service providers are not limited to private business operators. Public organizations such as local governments may also serve as service providers.

A control server 10 is a server that performs control related to behavior histories of users. The control server 10 generates cross-sectional behavior histories across a plurality of service providers. For example, the control server 10 generates a behavior history of a user based on information on services provided to the same user by service provider A and service provider B.

The control server 10 stores various types of IDs to realize generation of the above cross-sectional behavior histories. Specifically, the control server 10 stores a user ID commonly used in the system and an ID used by each service provider for management of users. In the following description, the ID of a user commonly used in the system is referred to as a “user ID,” and the ID used by each service provider for user management is referred to as an “individual ID.”

In addition, the control server 10 stores biometric information of users. The control server 10 stores a user ID, biometric information, and at least one or more individual IDs of a user in association with each other in a user management database. Details of the user management database will be described later.

It should be noted that examples of the biometric information include data (feature values) calculated from physical features unique to an individual, such as a face, a fingerprint, a voiceprint, a vein, a retina, or an iris pattern of an eye. Alternatively, biometric information may be image data such as a face image or fingerprint image. The biometric information may be anything that includes physical characteristics of a user as information. In the example embodiment of the present disclosure, a case will be described in which biometric information related to a human “face” (a face image or a feature value generated from a face image) is used.

As described above, the service providers provide services to users by using biometric authentication. For example, biometric authentication is performed in check-in procedures or entry and exit of guest rooms in hotels. Alternatively, biometric authentication is performed in entry and exit management or payment procedures in retail stores or the like.

As illustrated in FIG. 3, each service provider includes a service server 20 and at least one or more authentication terminals 30. The apparatuses (the service server 20, the authentication terminal 30) included in the service provider are connected to each other so as to be capable of communication. Specifically, the service server 20 and the authentication terminal 30 are connected by a wired or wireless communication means.

The service server 20 is connected to the control server 10 via a network. The service server 20 may be installed in a building of the service provider or may be installed on a cloud.

The service server 20 stores information necessary for providing a service to a user. Specifically, the service server 20 stores business information necessary for each service provider to provide a service using biometric authentication. The service server 20 stores the business information in a customer management database. Details of the customer management database will be described later.

For example, the service server 20 of a hotel stores, as business information, an individual ID (for example, a guest ID) of a guest, a name, a gender, an address, a date of birth, biometric information, contact information, reservation information, accommodation history, and the like. The reservation information includes, for example, accommodation dates (planned stay period: scheduled check-in date, scheduled check-out date), room type, and the like. The accommodation history includes, for example, check-in date and time, check-out date and time, and a room number in which the guest stayed.

Alternatively, the service server 20 of a retail store or the like stores, as business information, an individual ID (for example, a member ID) of a customer, a name, a gender, an address, a date of birth, biometric information, contact information, account information, purchase history, and the like. The account information includes, for example, credit card information for payment. The purchase history includes, for example, product purchase dates, names of purchased products, payment amounts, and the like.

An authentication terminal 30 is an apparatus that serves as an interface for a user receiving a service. The authentication terminal 30 is installed at each service provision location of each service provider. More specifically, the authentication terminal 30 is installed in a store or the like actually visited by a user.

The authentication terminal 30 has functions and forms according to the type of business or the like of the service provider. For example, the authentication terminal 30 installed in a hotel (in a lobby or front desk) is a signage-type or tablet-type terminal. Alternatively, the authentication terminal 30 installed in a retail store or restaurant is a tablet-type terminal. Alternatively, the authentication terminal 30 installed in a user's office or the like is a gate apparatus equipped with a gate.

A user or a system administrator possesses a terminal 40. The user or the like operates the terminal 40 to access the service server 20 or the like.

It should be noted that FIG. 3 is an example and is not intended to limit the configuration or the like of the information processing system of the present disclosure. For example, the information processing system may include two or more control servers 10. In addition, at least one or more service providers only need to participate in the information processing system. Furthermore, each service provider only needs to include at least one or more service servers 20 and at least one or more authentication terminals 30.

### Outline of Operation

Next, a schematic operation of the information processing system according to the first example embodiment will be described.

### <User Registration>

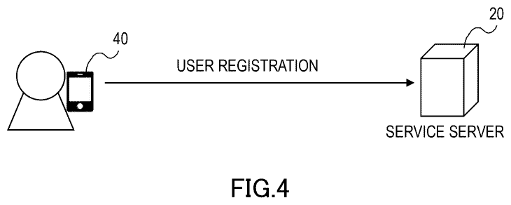

A user who wishes to receive a service from a service provider needs to perform user registration with the service provider. Specifically, the user operates the terminal 40 possessed by the user to access the service server 20 of a business operator from which the user wishes to receive a service (see FIG. 4).

For example, a user who wishes to use a hotel accesses the service server 20 of the hotel to perform user registration (a hotel reservation procedure). Alternatively, a user who wishes to use biometric authentication payment at a retail store or the like accesses a service server 20 of the retail store to perform user registration (membership registration).

The user inputs information such as name, gender, date of birth, address, biometric information, and contact information on a web page or the like provided by the service server 20. The service server 20 generates an individual ID for identifying the user upon acquiring the user's name and the like. For example, the service server 20 of a hotel generates a guest ID for identifying a guest. Alternatively, the service server 20 of a retail store generates a member ID for identifying its own member.

The service server 20 stores the generated individual ID, the acquired name, biometric information, and the like in association with each other in a customer management database.

### <ID Linkage>

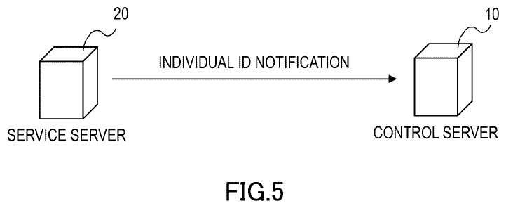

Each service server 20 of the service providers periodically or at a predetermined timing transmits an “individual ID notification” including an individual ID, biometric information, and a business operator code of a user to the control server 10 (see FIG. 5). For example, in a case where new user registration is performed, an individual ID, biometric information, and a business operator code of the newly registered user are notified to the control server 10.

A business operator code is identification information for identifying a service provider included in the information processing system. The business operator code is shared between the control server 10 and the service server 20 by any method. For example, a system administrator determines a business operator code and sets the determined business operator code in the service server 20. In addition, the system administrator inputs the determined business operator code and information related to the service provider into the control server 10. For example, the system administrator inputs into the control server 10 the name, address, contact information, homepage address, address of the service server 20, and the like of the service provider.

For example, the service server 20 of a hotel transmits to the control server 10 an individual ID notification including an individual ID, biometric information, and a business operator code of the hotel at a timing at which a reservation of a user is accepted or a reserver performs a check-in procedure.

As described above, the control server 10 stores, in association with each other, a user ID of a user commonly used in the system, biometric information of the user, and individual IDs used by respective service providers for managing the user.

In a case where an individual ID notification is received from the service server 20, the control server 10 performs matching processing using biometric information included in the request and biometric information stored in the user management database.

In a case where a user corresponding to the biometric information included in the individual ID notification is not registered in the user management database, the control server 10 adds a new entry to the user management database. The control server 10 stores the user ID, biometric information, and the individual ID of the service provider in the added entry.

In a case where a user corresponding to the biometric information included in the individual ID notification is registered in the user management database, the control server 10 adds the individual ID of the service provider to the entry identified through the matching processing.

### <Provision of Service>

A user who has completed user registration visits a service provider to receive a service. For example, the user visits a hotel or a store such as a retail shop.

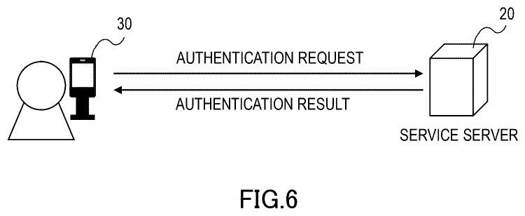

The authentication terminal 30 acquires biometric information of a user (a person to be authenticated) who receives the service. For example, the authentication terminal 30 captures the person to be authenticated and acquires a face image. The authentication terminal 30 transmits an “authentication request” including the acquired face image to the service server 20 (see FIG. 6).

It should be noted that the authentication terminal 30 may, as necessary, transmit other information (for example, a purchased product name or a product price) together with the biometric information to the service server 20.

The service server 20 performs biometric authentication using the biometric information included in the authentication request and the biometric information stored in the customer management database. Specifically, the service server 20 performs matching processing using the biometric information included in the authentication request and the biometric information stored in the customer management database. The service server 20 identifies a user (the person to be authenticated) registered in the customer management database through the matching processing.

The service server 20 performs authentication of the person to be authenticated by using business information of the identified user. For example, a service server 20 of a hotel determines that authentication is successful if the reservation information of the person to be authenticated who performs a check-in procedure is valid. Alternatively, in a case where payment for products or the like purchased by the person to be authenticated succeeds, the service server 20 of a retail store determines that authentication is successful.

The service server 20 transmits an authentication result (authentication success, authentication failure) to the authentication terminal 30.

The authentication terminal 30 executes processing corresponding to the authentication result. For example, in a case where authentication success is received, the authentication terminal 30 installed in a hotel notifies the user that a check-in procedure has been completed and informs the user of information such as an assigned room number. Alternatively, in a case where authentication success is received, the authentication terminal 30 installed in a retail store notifies the person to be authenticated that payment for a product has been completed.

In addition, the service server 20 stores, in the customer management database, a behavior history obtained through the authentication processing. For example, the service server 20 of a hotel stores, as accommodation history, information such as the date and time at which a check-in procedure is completed in the customer management database. Alternatively, the service server 20 of a retail store stores, as purchase history, information such as the purchase date and time of a product, the name of the purchased product, and the payment amount in the customer management database.

### <Generation and Provision of Behavior History>

The control server 10 can generate a behavior history of a user registered in the user management database. The control server 10 creates a behavior history in accordance with an external request and provides the created behavior history to an entity requesting provision of the behavior history.

For example, the control server 10 acquires a request for provision of a behavior history from a system administrator, a service provider (such as an employee of the service provider), or a business operator that does not provide services using biometric authentication to users (such as an employee of the business operator; for example, an employee of an advertising company).

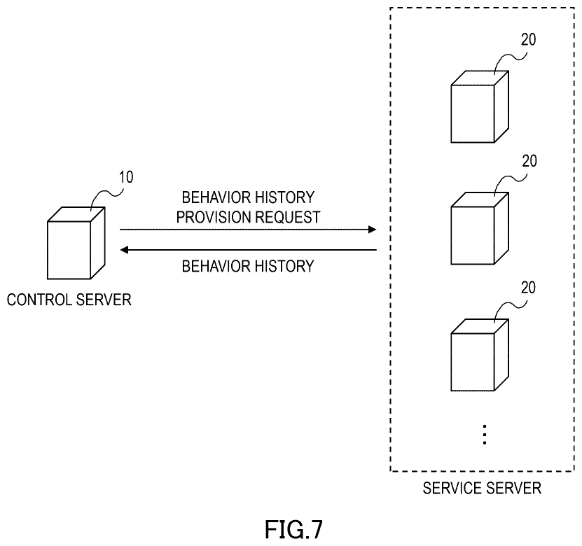

In a case where provision of a behavior history is requested, the control server 10 transmits, to the service servers 20 of respective service providers registered in the user management database, a “behavior history provision request” including a user ID of a user and individual IDs used by the respective service providers for managing the user (see FIG. 7).

The service server 20 transmits to the control server 10 a behavior history of the user stored in association with the individual ID included in the behavior history provision request, together with the user ID included in the behavior history provision request.

For example, the service server 20 of a hotel transmits to the control server 10 accommodation history (such as check-in date and time, check-out date and time, and room number) of a user corresponding to the individual ID notified from the control server 10. Alternatively, the service server 20 of a retail store transmits to the control server 10 purchase history (such as product purchase date and time, purchased product name, and payment amount) of a user.

The control server 10 integrates behavior histories provided from each service provider (individual behavior histories respectively held by the service providers; hereinafter also referred to as “individual behavior histories”) to generate a behavior history of the user. The control server 10 provides externally the generated behavior history (a behavior history obtained by integrating the individual behavior histories; hereinafter also referred to as integrated behavior history). The service providers or the like perform marketing and the like by using the provided behavior history.

Next, details of the individual apparatuses included in the information processing system according to the first example embodiment will be described.

### Control Server

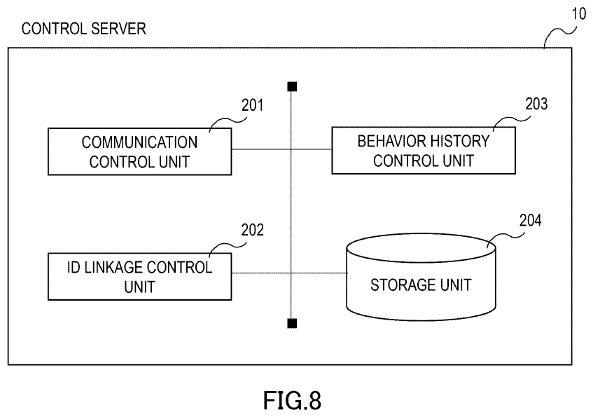

FIG. 8 is a diagram illustrating an example of a processing configuration (processing modules) of the control server 10 according to the first example embodiment. Referring to FIG. 8, the control server 10 includes a communication control unit 201, an ID linkage control unit 202, a behavior history control unit 203, and a storage unit 204.

The communication control unit 201 is means for controlling communication with other apparatuses. Specifically, the communication control unit 201 receives data (packets) from the service server 20. In addition, the communication control unit 201 transmits data to the service server 20. The communication control unit 201 gives data received from other apparatuses to other processing modules. The communication control unit 201 transmits data acquired from other processing modules to other apparatuses. In this way, other processing modules transmit and receive data to and from other apparatuses via the communication control unit 201. The communication control unit 201 includes a function as a receiving unit that receives data from other apparatuses and a function as a transmitting unit that transmits data to other apparatuses.

The ID linkage control unit 202 is means for executing control related to ID linkage of individual IDs used by the respective service providers for managing users.

The ID linkage control unit 202 acquires biometric information of a first user and a first individual ID used by a first service provider for managing the first user from the first service provider. The ID linkage control unit 202 performs matching processing using the biometric information of the first user that has been acquired and the biometric information stored in the user management database. In a case where matching processing succeeds, the ID linkage control unit 202 stores the first user's biometric information and the first individual ID in association with each other in an entry of the user management database identified by the matching processing.

In addition, the ID linkage control unit 202 acquires biometric information of a second user and a second individual ID used by a second service provider for managing the second user from the second service provider. The ID linkage control unit 202 performs matching processing using the biometric information of the second user that has been acquired and the biometric information stored in the user management database. In a case where matching processing fails, the ID linkage control unit 202 adds a new entry to the user management database and stores the second user's biometric information and the second individual ID in association with each other in the added entry.

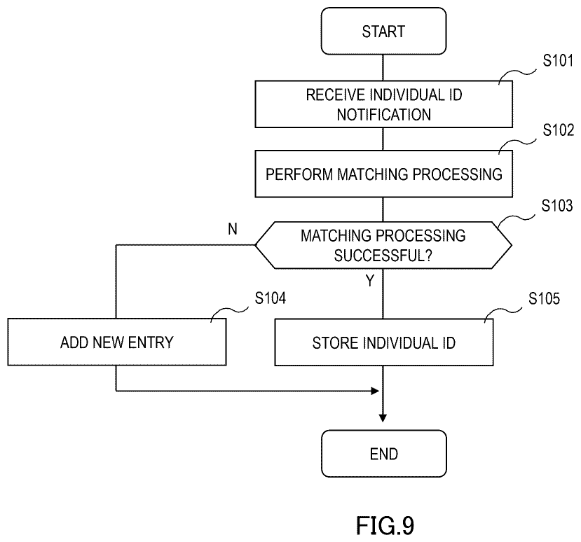

Hereinafter, the operation of the ID linkage control unit 202 will be described with reference to FIG. 9.

The ID linkage control unit 202 receives an individual ID notification from the service server 20 (step S101).

In a case where the individual ID notification is received, the ID linkage control unit 202 performs matching processing using biometric information included in the individual ID notification and biometric information stored in the user management database (step S102).

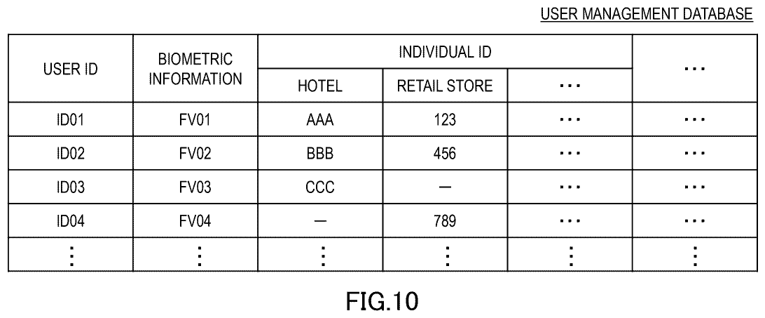

The user management database stores, in association with each other, a user ID, biometric information, and individual IDs for each service provider for each of a plurality of users (see FIG. 10). The user management database stores, for example, a feature value generated from a facial image as biometric information of a user.

It should be noted that the user management database shown in FIG. 10 is merely an example and is not intended to limit the stored items or the like. For example, a “face image” may be registered in the user management database as biometric information. In addition, although the user management database stores individual IDs of each service provider using business operator codes, the type of business of each service provider is described in FIG. 10 for ease of understanding.

In performing matching processing, the ID linkage control unit 202 generates a feature value from a face image included in the individual ID notification.

Since existing techniques can be used for the processing of generating feature values, detailed description thereof will be omitted. For example, the ID linkage control unit 202 extracts eyes, nose, mouth, and the like as feature points from a face image. Subsequently, the ID linkage control unit 202 calculates the position of each feature point and the distance between respective feature points as feature values, and generates a feature vector (vector information characterizing the face image) composed of a plurality of feature values.

Subsequently, the ID linkage control unit 202 sets the generated feature value as a feature value to be matched and the plurality of feature values stored in the user management database as registered feature values, and performs one-to-N matching (N being a positive integer, the same applies hereinafter). Specifically, the ID linkage control unit 202 calculates a degree of similarity between a feature value to be matched (feature vector) and each of the plurality of registered feature values. The degree of similarity may be calculated using, for example, a chi-square distance or a Euclidean distance. It should be noted that a longer distance represents a lower similarity, and a shorter distance represents a higher similarity.

In a case where no feature value having a degree of similarity equal to or higher than a predetermined value exists, the ID linkage control unit 202 determines that the matching processing has failed. In a case where a feature value having a degree of similarity equal to or higher than a predetermined value exists, the ID linkage control unit 202 determines that the matching processing has succeeded. In a case where matching processing succeeds, an entry having the highest degree of similarity is identified.

In a case where the matching processing fails (step S103, No branch), the ID linkage control unit 202 adds a new user (a new entry) to the user management database (step S104).

The ID linkage control unit 202 generates a user ID for managing the new user. It should be noted that the user ID may be any information capable of uniquely identifying a user in the information processing system. For example, the ID linkage control unit 202 may assign a unique value each time an individual ID notification is processed and use the assigned value as the user ID.

The ID linkage control unit 202 stores the generated user ID, a feature value (biometric information) generated from a face image, and the individual ID in the added entry. With regard to the registration of the individual ID, the ID linkage control unit 202 stores the individual ID acquired from the service server 20 in an individual ID field corresponding to the business operator code included in the individual ID notification.

In a case where the matching processing succeeds (step S103, Yes branch), the ID linkage control unit 202 stores the individual ID in the entry identified through the matching processing (step S105).

The ID linkage control unit 202 stores the individual ID acquired from the service server 20 in an individual ID field corresponding to the business operator code included in the individual ID notification (the individual ID field of the entry identified through the matching processing).

The behavior history control unit 203 is means for executing control related to a user's behavior history.

The behavior history control unit 203 acquires a request for provision of a behavior history from an external business operator or the like. An employee or the like of the business operator operates a terminal 40 in their possession to access a website for acquiring (referring to) a behavior history. The employee or the like requests provision of a user's behavior history on the website.

In a case where provision of a behavior history is requested, the behavior history control unit 203 transmits a “behavior history provision request” to each service server 20 of the service providers registered in the user management database. The behavior history control unit 203 transmits to each service server 20 of the service providers a behavior history provision request including a combination of a user ID of a user and an individual ID of a service provider.

For example, the behavior history control unit 203 transmits to the service server 20 of a hotel a behavior history provision request including a guest ID (individual ID) used by the hotel for managing guests. In the example of FIG. 10, the behavior history control unit 203 transmits to the service server 20 of the hotel a behavior history provision request including user ID “ID01” and individual ID “AAA.” Similarly, the behavior history control unit 203 transmits to the service server 20 of the hotel behavior history provision requests including user ID “ID02” and individual ID “BBB,” and user ID “ID03” and individual ID “CCC.”

Alternatively, the behavior history control unit 203 transmits to the service server 20 of a retail store a behavior history provision request including a member ID (individual ID) used by the retail store for managing members. In the example of FIG. 10, behavior history provision requests including combinations of user ID “ID01” and individual ID “123,” user ID “ID02” and individual ID “456,” and user ID “ID04” and individual ID “789,” respectively, are transmitted to the service server 20.

It should be noted that the behavior history control unit 203 may transmit one behavior history provision request for each service provider. In the example of the hotel described above, one behavior history provision request including three combinations of user IDs and individual IDs may be transmitted to the service server 20 of the hotel.

The behavior history control unit 203 acquires from each service server 20 a user ID of a user and a behavior history of the user (an individual behavior history at each service provider). The behavior history control unit 203 associates behavior histories using the user IDs acquired from each service server 20 and generates an integrated behavior history for each user. That is, the behavior history control unit 203 integrates the individual behavior histories acquired from each service server 20 and generates a behavior history of each user.

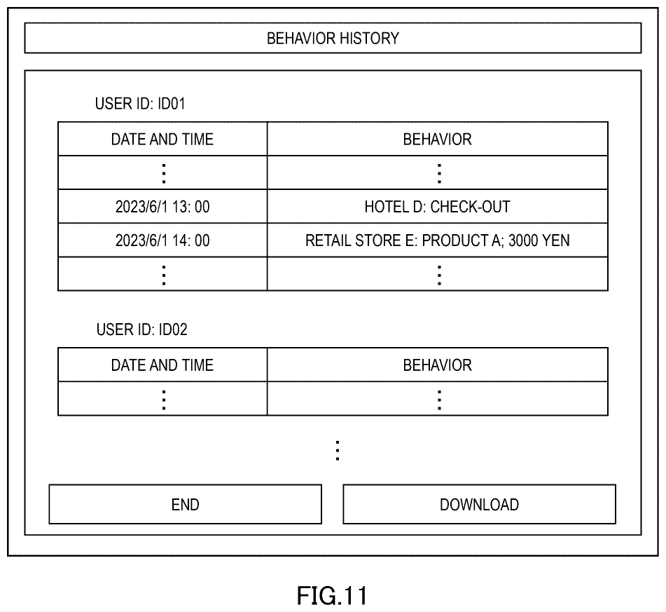

The behavior history control unit 203 provides the generated behavior histories (integrated behavior histories for each user) to external business operators or the like. For example, the behavior history control unit 203 displays, on a website or the like accessed by an employee or the like of an external business operator, a screen such as that shown in FIG. 11. The behavior history control unit 203 generates a behavior history presentation screen, such as that shown in FIG. 11, by arranging in chronological order the contents of individual behavior histories of users having the same user ID acquired from each service provider.

It should be noted that, in a case where an employee or the like of an external business operator requests downloading of a behavior history (for example, upon pressing a download button shown in FIG. 11), the behavior history control unit 203 transmits a file including the integrated behavior history to the terminal 40.

In this way, the behavior history control unit 203 transmits, to each of a plurality of service providers, an individual ID used by each service provider for managing users, thereby acquiring from each service provider a behavior history corresponding to the individual ID. Furthermore, the behavior history control unit 203 provides externally an integrated behavior history in which the acquired behavior histories are integrated.

The storage unit 204 is means for storing information necessary for an operation of the control server 10. A user management database is constructed in the storage unit 204. The user management database stores, for each of a plurality of users, biometric information in association with individual IDs for a plurality of service providers that provide services using biometric authentication.

### Service Server

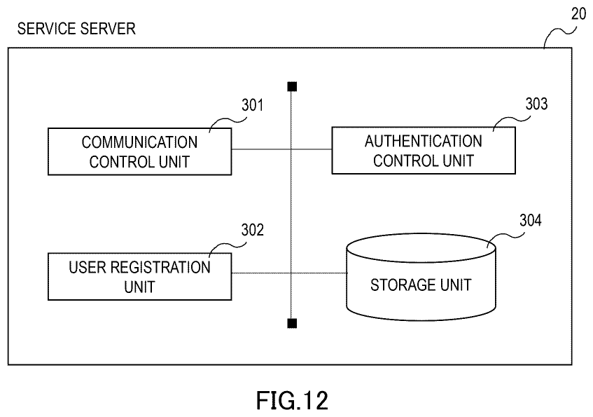

FIG. 12 is a diagram illustrating an example of a processing configuration (processing modules) of the service server 20 according to the first example embodiment. Referring to FIG. 12, the service server 20 includes a communication control unit 301, a user registration unit 302, an authentication control unit 303, and a storage unit 304.

The communication control unit 301 is means for controlling communication with other apparatuses. For example, the communication control unit 301 receives data (packets) from the control server 10. In addition, the communication control unit 301 transmits data to the control server 10. The communication control unit 301 gives data received from other apparatuses to other processing modules. The communication control unit 301 transmits data acquired from other processing modules to other apparatuses. In this way, other processing modules transmit and receive data to and from other apparatuses via the communication control unit 301. The communication control unit 301 includes a function as a receiving unit that receives data from other apparatuses and a function as a transmitting unit that transmits data to other apparatuses.

The user registration unit 302 is means for implementing user registration. The user registration unit 302 acquires business information such as a name, gender, date of birth, address, biometric information, and contact information of a user who has accessed a predetermined website or the like by operating a terminal 40.

In addition, the user registration unit 302 acquires information necessary for business provision by each service provider. For example, the user registration unit 302 of the service server 20 of a hotel acquires reservation information relating to accommodation reservations. Alternatively, the user registration unit 302 of the service server 20 of a retail store acquires account information (for example, credit card information) for biometric authentication payment.

In a case where business information such as a name, gender, and biometric information is acquired, the user registration unit 302 generates an individual ID (for example, a guest ID of a hotel or a member ID of a retail store) for managing each user. In addition, in a case where the user registration unit 302 acquires a face image as biometric information, the user registration unit 302 generates a feature value from the face image. Alternatively, the user registration unit 302 may acquire an individual ID from a user. For example, the user registration unit 302 may acquire an email address as an individual ID.

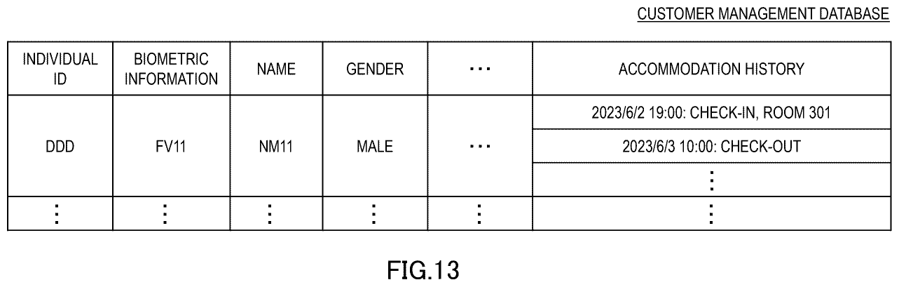

The user registration unit 302 stores a generated individual ID, name, gender, biometric information (feature value), and the like in a customer management database (see FIG. 13). The customer management database shown in FIG. 13 is an example, and is not intended to limit items to be stored or the like. For example, a “face image” may be registered in the customer management database as biometric information. It should be noted that FIG. 13 illustrates an example of a customer management database provided in the service server 20 of a hotel.

In a case where user registration is completed, the user registration unit 302 transmits to the control server 10 an “individual ID notification” including the individual ID, biometric information (for example, a face image) for the user whose registration has been completed and the business operator code of the company.

The authentication control unit 303 is means for controlling biometric authentication of a person to be authenticated.

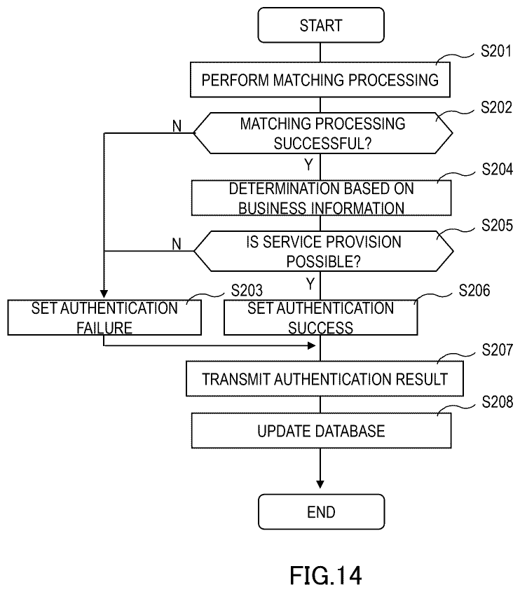

FIG. 14 is a flowchart illustrating an example of an operation of the authentication control unit 303 according to the first example embodiment. The operation of the authentication control unit 303 will be described with reference to FIG. 14.

In a case where an authentication request is received from the authentication terminal 30, the authentication control unit 303 performs matching processing using biometric information (step S201).

Specifically, the authentication control unit 303 generates a feature value from a face image included in the authentication request. The authentication control unit 303 performs matching processing using the generated feature value and a feature value registered in the customer management database.

In a case where the matching processing fails (step S202, No branch), the authentication control unit 303 sets “authentication failure” as the authentication result (step S203).

In a case where the matching processing succeeds (step S202, Yes branch), the authentication control unit 303 determines, using business information of the person to be authenticated identified by the matching processing, whether service provision to the person to be authenticated is possible. The authentication control unit 303 determines availability of service provision using all or part of the business information (step S204).

For example, the authentication control unit 303 of the service server 20 of a hotel determines that service provision is possible if reservation information of the person to be authenticated who performs a check-in procedure is valid (that is, if the date of the visit corresponds to the scheduled check-in date). Alternatively, the authentication control unit 303 of the service server 20 of a retail store or the like determines that service provision is possible in a case where payment of a product price using credit card information or the like is successful.

It should be noted that a more detailed description of authentication processing using business information in each service provider will be omitted. This is because the processing specific to each service provider is different from the purpose of the present application.

In a case where service provision is impossible (step S205, No branch), the authentication control unit 303 sets “authentication failure” as the authentication result (step S203).

In a case where service provision is possible (step S205, Yes branch), the authentication control unit 303 sets “authentication success” as the authentication result (step S206).

The authentication control unit 303 transmits the authentication result (authentication success or authentication failure) to the authentication terminal 30 (step S207).

In a case of authentication failure, the authentication control unit 303 transmits to the authentication terminal 30 a negative response indicating that fact.

In a case of authentication success, the authentication control unit 303 transmits to the authentication terminal 30 a positive response indicating that fact. At that time, the authentication control unit 303 transmits to the authentication terminal 30 a positive response including information necessary for providing a service to the user, as required. In the example of a hotel check-in procedure, a room number assigned to the guest is transmitted to the authentication terminal 30.

In addition, in a case of authentication success, the authentication control unit 303 performs an update of the customer management database (database update; step S208).

Specifically, the authentication control unit 303 adds to the customer management database a behavior history (an individual behavior history held by each service provider) of a successful authenticated person (a person to be authenticated determined to have authentication success).

For example, the authentication control unit 303 of a hotel stores information such as check-in date and time, check-out date and time, and room number in an accommodation history field. Alternatively, the authentication control unit 303 of a retail store stores information such as product purchase date and time, purchased product name, and payment amount in a purchase history field.

The storage unit 304 is means for storing information necessary for an operation of the service server 20. A customer management database is constructed in the storage unit 304. The customer management database stores an individual ID of a registered user in association with a behavior history.

### Authentication Terminal

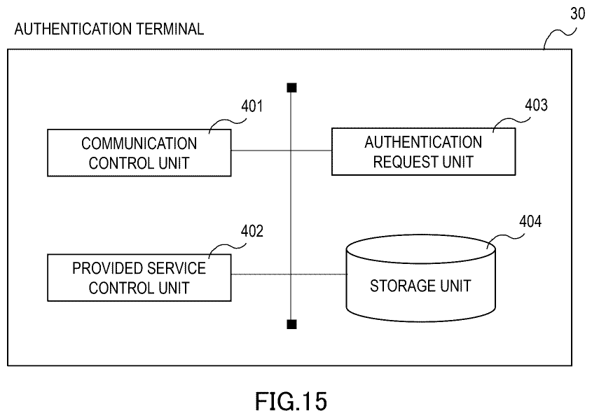

FIG. 15 is a diagram illustrating an example of a processing configuration (processing modules) of the authentication terminal 30 according to the first example embodiment. Referring to FIG. 15, the authentication terminal 30 includes a communication control unit 401, a provided service control unit 402, an authentication request unit 403, and a storage unit 404.

The communication control unit 401 is means for controlling communication with other apparatuses. Specifically, the communication control unit 401 receives data (packets) from the service server 20. In addition, the communication control unit 401 transmits data to the service server 20. The communication control unit 401 gives data received from other apparatuses to other processing modules. The communication control unit 401 transmits data acquired from other processing modules to other apparatuses. In this way, other processing modules transmit and receive data to and from other apparatuses via the communication control unit 401. The communication control unit 401 includes a function as a receiving unit for receiving data from other apparatuses, and a function as a transmitting unit for transmitting data to other apparatuses.

The provided service control unit 402 is means for performing control related to a service to be provided to a user. The provided service control unit 402 realizes a function that is assigned to the authentication terminal 30.

In a case where the user desires to receive a service, the provided service control unit 402 acquires biometric information (for example, a face image) of the user (the person to be authenticated). For example, the provided service control unit 402 captures an image of an area in front of the apparatus itself periodically or at a predetermined timing. The provided service control unit 402 determines whether or not a human face image is included in the acquired image, and in a case where a face image is included, the provided service control unit 402 extracts the face image from the acquired image data.

It should be noted that, since existing technologies can be used for the face image detection processing and the face image extraction processing performed by the provided service control unit 402, a detailed description thereof will be omitted. For example, the provided service control unit 402 may extract a face image (face region) from image data by using a trained model that has been trained by a CNN (Convolutional Neural Network). Alternatively, the provided service control unit 402 may extract a face image by using a technique such as template matching or the like.

The provided service control unit 402 passes the acquired biometric information (for example, a face image) to the authentication request unit 403.

The authentication request unit 403 is means for requesting the service server 20 to perform an authentication of a person to be authenticated. When authentication of the person to be authenticated becomes necessary, the authentication request unit 403 transmits an authentication request including the biometric information of the person to be authenticated (the user in front of the authentication terminal 30) to the service server 20.

The authentication request unit 403 receives an authentication result (authentication success, authentication failure) from the service server 20. The authentication request unit 403 passes the received authentication result to the provided service control unit 402.

For example, the provided service control unit 402 of the authentication terminal 30 installed in a hotel lobby displays a room number assigned to a user who performs a check-in procedure.

In a case where authentication failure is received, the provided service control unit 402 may output a predetermined message or the like.

It should be noted that a more detailed description related to the provided service control unit 402 included in the authentication terminal 30 of each service provider is omitted. This is because the realization of the functions of the authentication terminal 30 by the provided service control unit 402 is different from the purpose of the present application disclosed.

The storage unit 404 is means for storing information necessary for an operation of the authentication terminal 30.

### Terminal

Examples of the terminal 40 include a portable terminal device such as a smartphone, a portable phone, a game console, or a tablet and a computer (a personal computer or a laptop computer). The terminal 40 can be any apparatus or device insofar as it accepts user operations and is capable of communicating with the service server 20 or the like. Further, since the configuration, and so on, of the terminal 40 is obvious to those skilled in the art, a detailed description will be omitted.

### System Operation

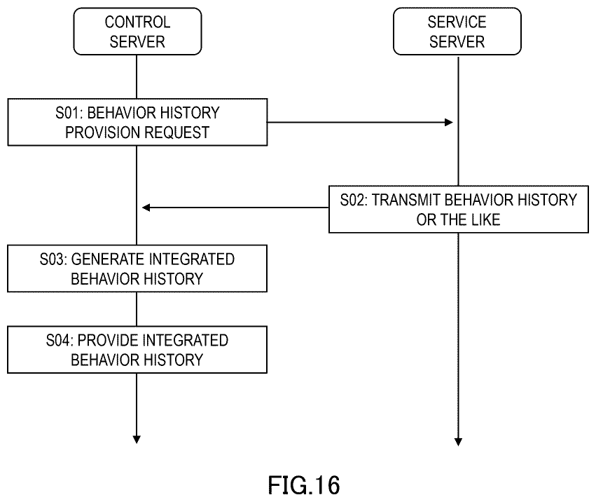

Next, operations of the information processing system according to the first example embodiment will be described. With reference to FIG. 16, the operations of the information processing system related to the provision of behavior histories will be described.

In response to a request from a business operator or the like who desires provision of behavior histories, the control server 10 transmits to the service server 20 a behavior history provision request including individual IDs managed by respective service providers (step S01).

Each service server 20 transmits to the control server 10 behavior histories of users corresponding to the individual IDs included in the behavior history provision request (step S02).

The control server 10 integrates individual behavior histories received from each service server 20 to generate an integrated behavior history (step S03).

The control server 10 provides the generated integrated behavior history to a business operator or the like who desires provision of behavior histories (step S04).

Next, variations according to the first example embodiment will be described.

### Variation 1

In the above-described example embodiment, a case has been described in which the service server 20 notifies the control server 10 of an individual ID and biometric information of a user in a case where user registration is completed (in a case where biometric information of the user is acquired).

The service server 20 may notify the control server 10 of the individual ID and biometric information in a case where user authentication succeeds (in a case where a service is provided to the user). In this case, the service server 20 only needs to transmit an individual ID notification including an individual ID, biometric information, and a business operator code to the control server 10 in a case where authentication of the user is successful for the first time.

Alternatively, the service server 20 may transmit an individual ID notification to the control server 10 each time in a case where user authentication succeeds. In this case, in a case where the individual ID is not stored in the user management database, the control server 10 only needs to store, in the user management database, the individual ID included in the individual ID notification.

### Variation 2

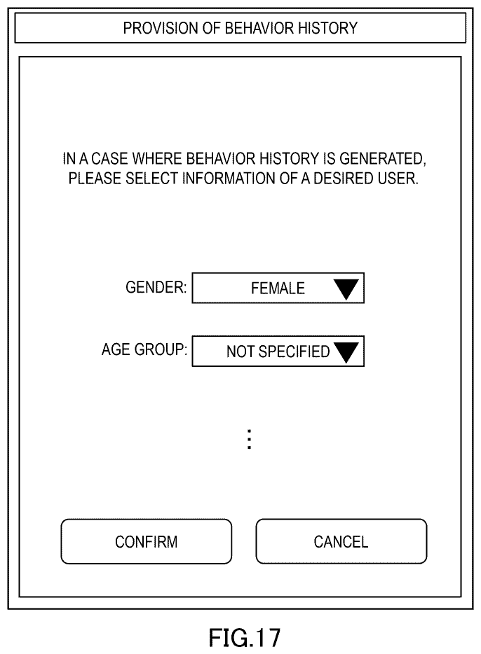

The control server 10 may provide to a business operator or the like who desires provision of behavior histories an interface for narrowing down (specifying) users to be targeted for generation of behavior histories. Specifically, the behavior history control unit 203 may acquire attribute information (for example, gender or age group) of users to be targeted for generation of behavior histories by using a graphical user interface (GUI) such as that shown in FIG. 17.

In this case, the behavior history control unit 203 transmits to each service server 20 a behavior history provision request including attribute information of users to be targeted for generation of behavior histories (attribute information specified by external business operators or the like).

Each service server 20 transmits to the control server 10 behavior histories of users matching the specified attributes. For example, in a case where behavior histories of female users are specified, the service server 20 transmits to the control server 10 behavior histories of female users (for example, accommodation histories or meal histories).

The behavior history control unit 203 can generate integrated behavior histories of users having attributes specified by external business operators or the like by using behavior histories (individual behavior histories) narrowed down based on attribute information. External business operators or the like can perform efficient and accurate marketing using the obtained behavior histories.

As described above, the control server 10 may transmit to each of a plurality of service providers the individual ID used by each service provider for managing users and attribute information specifying a user to be targeted for generation of behavior histories. By transmitting the individual IDs and attribute information, the control server 10 may obtain from each of the plurality of service providers the behavior histories corresponding to individual IDs of the user specified by external business operators or the like.

### Variation 3

In the first example embodiment including the above-described variation 2, a case where attribute information (such as gender or age) of users is not stored in the user management database of the control server 10 has been described. However, the control server 10 may store attribute information (such as gender or age) of users in the user management database. The attribute information may be acquired from the service providers. Specifically, the service server 20 transmits to the control server 10 an individual ID notification including the attribute information of users.

In this case, the control server 10 may specify behavior histories provided by the service server 20 by using individual IDs of users. For example, in a case where provision of behavior histories of “male” users is requested from a business operator or the like, the behavior history control unit 203 extracts “male” users registered in the user management database and transmits to each service server 20 a “behavior history provision request” including the individual IDs of the extracted users.

Each service server 20 transmits to the control server 10 individual behavior histories of users corresponding to the individual IDs included in the behavior history provision request. The control server 10 integrates the obtained individual behavior histories to generate integrated behavior histories to be provided to external business operators or the like.

As described above, the control server 10 may store, in the user management database, biometric information, individual IDs for each of a plurality of service providers providing services using biometric authentication, and attribute information in association with each other for each of a plurality of users. In that case, the control server 10 extracts, from among the plurality of users, users to be targeted for generation of behavior histories based on the attribute information. The control server 10 acquires from each of the plurality of service providers behavior histories of users corresponding to the individual IDs by transmitting to each service provider the individual IDs used by the service provider for managing the extracted users. The control server 10 integrates the obtained behavior histories and provides the integrated behavior histories externally.

As described above, the control server 10 according to the first example embodiment acquires an individual ID and biometric information used by a service provider for managing a user, and identifies a user registered in the user management database by using the acquired biometric information. The control server 10 stores the acquired individual ID in the entry of the identified user. In this manner, the control server 10 performs matching (association) of individual IDs used by respective different service providers by using biometric information of users.

Biometric information has characteristics such as universality in that all people possess it, uniqueness in that it differs from person to person, and permanence in that it remains unchanged throughout life. The control server 10 can perform association of individual IDs for any person by virtue of the universality of biometric information. In addition, the control server 10 can accurately perform association of individual IDs by virtue of the uniqueness of biometric information. Furthermore, the control server 10 can perform association of individual IDs at any time or timing by virtue of the permanence of biometric information.

In addition, the control server 10 can generate behavior histories useful for external business operators or the like across a plurality of service providers by collecting behavior histories from the respective service providers using the individual IDs held by each service provider.

### Second Example Embodiment

Next, a second example embodiment will be described in detail with reference to drawings.

In the first example embodiment, a case has been described in which the control server 10 obtains individual behavior histories necessary for generating an integrated behavior history by requesting the service server 20 to provide behavior histories. In the second example embodiment, a case will be described in which the control server 10 obtains individual behavior histories by receiving notifications of the individual behavior histories from the service server 20 each time authentication of a person to be authenticated succeeds.

It should be noted that, as the information processing system according to the second example embodiment can have the same configuration as that according to the first example embodiment, the description corresponding to FIG. 3 will be omitted. In addition, since the processing configurations of the control server 10, the service server 20, and the like according to the second example embodiment can also be the same as those in the first example embodiment, their descriptions will be omitted.

The following description will be made with a focus on the difference between the first example embodiment and the second example embodiment.

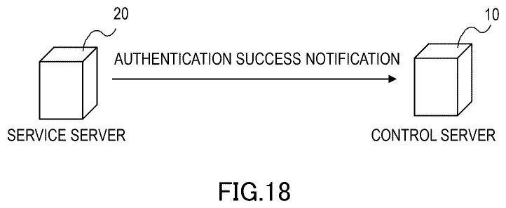

Each service server 20 of the respective service providers notifies the control server 10 of the fact of authentication success each time authentication of a person to be authenticated succeeds. Specifically, the authentication control unit 303 of the service server 20 transmits to the control server 10 an “authentication success notification” including an individual ID of the person to be authenticated whose authentication has succeeded, a business operator code of its own, and a behavior history (individual behavior history) generated upon authentication success (see FIG. 18).

The behavior history control unit 203 of the control server 10 processes the authentication success notification. Specifically, the behavior history control unit 203 searches the user management database using a business operator code and an individual ID included in the authentication success notification as keys and identifies a corresponding entry.

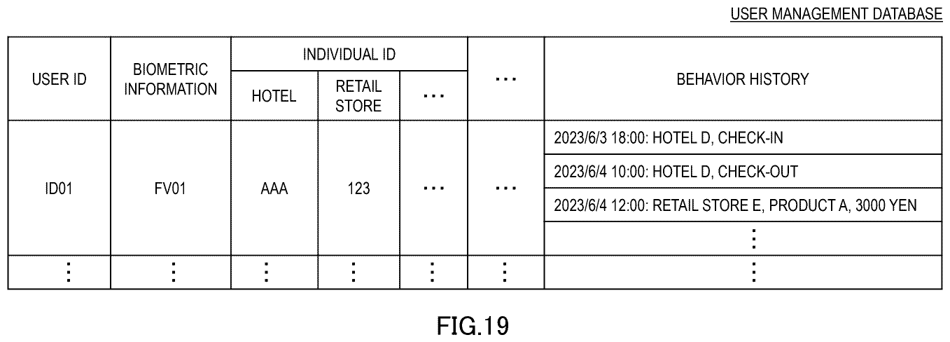

The behavior history control unit 203 stores, in a behavior history field of the identified entry, a behavior history (individual behavior history) included in the authentication success notification. As a result, the user management database as shown in FIG. 19 is generated.

In a case where provision of a user's behavior history is requested from an external business operator or the like, the behavior history control unit 203 generates a behavior history to be provided to the business operator or the like using the behavior histories stored in the user management database.

In this manner, each service server 20 of the service providers may notify the control server 10 of a behavior history (for example, accommodation history or purchase history) each time a service is provided to a user. For example, the individual ID and the behavior history of a user may be transmitted to the control server 10 at the timing of the user's check-in, check-out, or completion of biometric authentication payment. In this case, the control server 10 identifies the user who has received the service using the individual ID and stores the behavior history in the entry of the identified user.

More specifically, the ID linkage control unit 202 of the control server 10 receives, from a service provider that has succeeded in biometric authentication of a person to be authenticated, an authentication success notification including an individual ID and a behavior history of the person to be authenticated whose biometric authentication has succeeded. The ID linkage control unit 202 stores, in an entry of the user management database corresponding to the individual ID included in the authentication success notification, the behavior history included in the authentication success notification.

Next, variations according to the second example embodiment will be described.

### Variation 1

The service server 20 may transmit an authentication history to the control server 10 instead of a behavior history. Specifically, the service server 20 transmits to the control server 10 an authentication success notification including an individual ID of a user, its own business operator code, and an authentication history (such as authentication date and time, and authentication location).

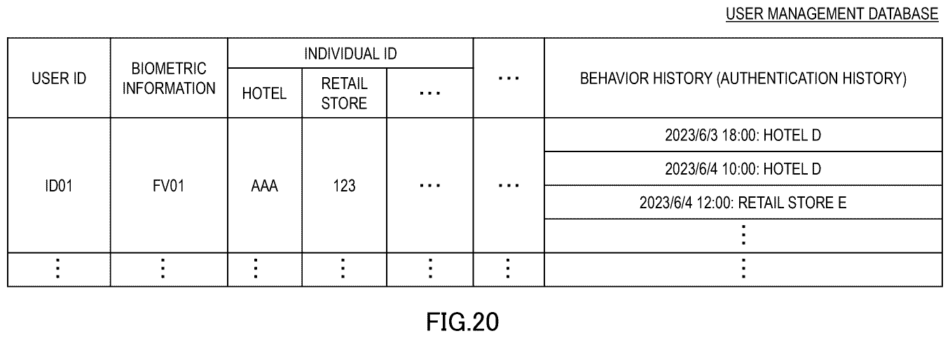

The control server 10 stores, in the user management database, the authentication history included in the received authentication success notification. As a result, the user management database as shown in FIG. 20 is generated.

In a case where provision of a user's behavior history is requested from an external business operator or the like, the behavior history control unit 203 of the control server 10 generates a behavior history to be provided to the business operator or the like using the authentication history stored in the user management database.

The control server 10 can provide externally an integrated behavior history consisting of dates, times, and locations where a user received services using biometric authentication.

Thus, the service server 20 may notify the control server 10 of dates and locations (authentication history) at which a user received services using biometric authentication instead of a detailed behavior history of the user. That is, the control server 10 can not only generate a detailed behavior history by linking data held by respective service providers but also generate a simplified behavior history without linking the data held by the service providers. The ID linkage control unit 202 of the control server 10 receives, from a service provider that has succeeded in biometric authentication of a person to be authenticated, an authentication success notification including an individual ID and an authentication history of the person to be authenticated whose biometric authentication has succeeded. The ID linkage control unit 202 stores, in an entry of the user management database corresponding to the individual ID included in the authentication success notification, the authentication history included in the authentication success notification.

The control server 10 can also generate a simplified behavior history consisting of the locations and dates at which a user received services, using the authentication date, time, and location (information regarding the installation location of the authentication terminal 30; edge information). In this case, the control server 10 does not need to obtain detailed behavior histories of users from the respective service servers 20.

Thus, the control server 10 can generate a detailed behavior history by integrating the data of the respective service servers 20 using various ID information within the control server as a common master, or can generate a simplified behavior history without integrating the data of the service servers 20.

As described above, the service server 20 according to the second example embodiment transmits, to the control server 10, a behavior history or an authentication history of a user each time authentication of the user succeeds. The control server 10 can generate a behavior history spanning a plurality of service providers by using the behavior histories and the like collected from each service provider.

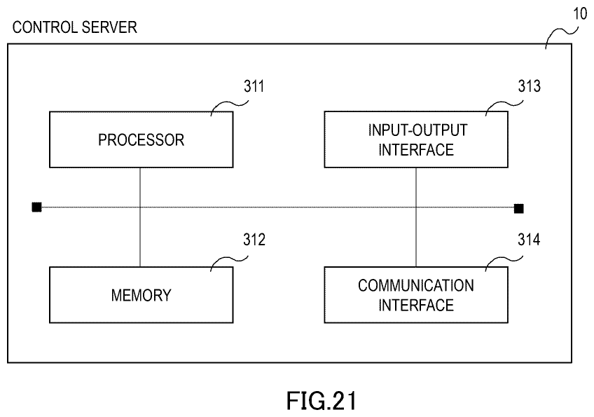

Next, a hardware configuration of an individual apparatus that constitutes the information processing system will be described. FIG. 21 is a diagram illustrating an example of a hardware configuration of the control server 10.

The control server 10 can be configured by an information processing apparatus (a so-called computer) and has a configuration illustrated as an example in FIG. 21. For example, the control server 10 includes a processor 311, a memory 312, an input-output interface 313, a communication interface 314, and the like. The above-described components such as the processor 311 are connected via an internal bus or the like and are configured to be capable of communicating with each other.

However, the configuration shown in FIG. 21 is not intended to limit the hardware configuration of the control server 10. The control server 10 may include hardware not illustrated in the figure, and may omit the input-output interface 313 as needed. In addition, the number of components such as the processor 311 included in the control server 10 is not intended to be limited to the example shown in FIG. 21, and, for example, a plurality of processors 311 may be included in the control server 10.

For example, the processor 311 is a programmable device such as a CPU (Central Processing Unit), an MPU (Micro Processing Unit), or a DSP (Digital Signal Processor). Alternatively, the processor 311 may be a device such as an FPGA (Field Programmable Gate Array) or an ASIC (Application Specific Integrated Circuit). The processor 311 executes various kinds of programs including an operating system (OS).

The memory 312 is a RAM (Random Access Memory), a ROM (Read-Only Memory), an HDD (Hard Disk Drive), an SSD (Solid State Drive), or the like. The memory 312 stores an OS program, an application program, and various kinds of data.

The input-output interface 313 is an interface for a display apparatus and an input apparatus not illustrated. The display apparatus is, for example, a liquid crystal display or the like. For example, the input apparatus is an apparatus that receives user operations, and examples of the input apparatus include a keyboard and a mouse.

The communication interface 314 is a circuit, a module, or the like for performing communication with other apparatuses. For example, the communication interface 314 includes a NIC (Network Interface Card) or the like.

The functions of the control server 10 are realized by various kinds of processing modules. The processing modules are realized, for example, by causing the processor 311 to execute a program stored in the memory 312. In addition, this program can be recorded in a computer-readable storage medium. The storage medium may be a non-transient (non-transitory) storage medium, such as a semiconductor memory, a hard disk, a magnetic recording medium, or an optical recording medium. That is, the present invention can be embodied as a computer program product. In addition, the above program may be updated by downloading a program via a network or by using a storage medium in which a program is stored. In addition, the above processing modules may be realized by semiconductor chips.

It should be noted that the service server 20, the authentication terminal 30, the terminal 40, and the like can also be configured by information processing apparatuses in the same manner as the control server 10, and since the specific hardware configurations of the service server 20, the authentication terminal 30, the terminal 40, and the like are not different from that of the control server 10, a detailed description thereof will be omitted. For example, it is sufficient for the authentication terminal 30 to include a camera apparatus for capturing an image of the person to be authenticated.

The control server 10, which is an information processing apparatus, is equipped with a computer, and the functions of the control server 10 can be realized by causing the computer to execute a program. In addition, the control server 10 executes a control method of the control server 10 by using the program. Similarly, the service server 20, which is an information processing apparatus, is equipped with a computer, and the functions of the service server 20 can be realized by causing the computer to execute a program. In addition, the service server 20 executes a control method of the service server 20 by using the program.

### Variations

It should be noted that the configurations, operations, and the like of the information processing system according to the above example embodiments are examples and do not limit the present system configuration or the like.

A service provider (the service server 20) may obtain consent from a user at the time of user registration regarding providing the user's biometric information and individual ID to other business operators or generating a behavior history using the provided biometric information or the like. The service server 20 does not transmit an individual ID notification to the control server 10 related to a user from whom consent for providing biometric information or the like has not been obtained. As a result, a behavior history regarding a service provider to which the user has not given consent is not generated. It should be noted that a user can determine consent or non-consent to the provision of biometric information or the like for each service provider. As a result, the user can, for example, permit the control server 10 to provide externally a behavior history related to hotel stays or the like, while not permitting the control server 10 to provide externally a behavior history (payment information) related to retail stores or the like.

The service server 20 may notify the control server 10 of the updated biometric information and the individual ID at a timing in which the biometric information registered in the customer management database is updated.

The control server 10 may provide an interface that allows an external business operator or the like, in specifying a target user for behavior history generation, to designate a period in which behavior histories were acquired by each service provider. For example, the external business operator or the like may select provision of a one-month behavior history, a six-month behavior history, or the like.

A service provider may prompt a user who has not registered biometric information to register such biometric information in a case where a service is provided to the user. For example, the service provider may recommend biometric authentication payment to a user who wishes to make a cash payment at a restaurant or the like. In this case, the service provider (the service server 20) may grant a benefit such as a discount or points to a user who registers biometric information.

In the first example embodiment, a case has been described in which the service server 20 transmits to the control server 10 an individual ID notification including a face image of a user. That is, in the first example embodiment, it has been described that user matching is possible even if the control server 10 and the service server 20 adopt different biometric authentication algorithms, by transmitting and receiving a face image between the control server 10 and the service server 20. However, in a case where the control server 10 and the service server 20 adopt the same biometric authentication algorithm, the service server 20 may transmit to the control server 10 an individual ID notification including a feature value generated from a user's face image. The control server 10 may identify a user who has been registered with a service provider by using the feature value.

In the above example embodiment, a case has been described in which a user management database is configured inside the control server 10, but the database may be constructed in an external database server or the like. That is, some of the functions of the control server 10 may be implemented in another server. More specifically, the “ID linkage control unit (ID linkage control means)” and the like described above, can be implemented in any of the apparatuses included in the system.

A data transmission and reception format among the respective apparatuses (the control server 10, the service server 20, and the authentication terminal 30) is not particularly limited, but data transmitted and received among these apparatuses may be encrypted. Among these apparatuses, biometric information or the like is transmitted and received, and in order to appropriately protect such information, it is desirable that encrypted data be transmitted and received.

In the flowcharts and sequence diagrams used in the above description, a plurality of steps (processes) are sequentially described. However, the order of the execution of the steps performed in the individual example embodiment is not limited to the described order. In the individual example embodiment, the order of the illustrated steps may be changed to the extent that a problem is not caused on the content of the individual example embodiment. For example, individual processes may be executed in parallel.

The above example embodiments have been described in detail to facilitate the understanding of the present application disclosed and not to mean that all the configurations described above are needed. In addition, if a plurality of example embodiments have been described, each of the example embodiments may be used individually or a plurality of example embodiments may be used in combination. For example, part of a configuration according to one example embodiment may be replaced by a configuration according to another example embodiment. For example, a configuration according to one example embodiment may be added to a configuration according to another example embodiment. In addition, addition, deletion, or replacement is possible between part of a configuration according to one example embodiment and another configuration.

The industrial applicability of the present invention has been made apparent by the above description. That is, the present invention is suitably applicable, for example, to an information processing system or the like that provides a user's behavior history.

A part or the entirety of the example embodiments described above may be described as in the following supplementary notes, but is not limited to the followings.

### Supplementary Note 1

A server apparatus including:
a storage means that stores, for a plurality of users, biometric information and individual IDs, the individual IDs being IDs for each of a plurality of service providers each of which provide services using biometric authentication, in a database in association with each other; and
an ID linkage control means that acquires, from a first service provider, biometric information of a first user and a first individual ID used by the first service provider for managing the first user, and stores, in a case where matching processing using the acquired biometric information of the first user and the biometric information stored in the database succeeds, the biometric information of the first user and the first individual ID in association with each other in an entry of the database identified by the matching processing.

### Supplementary Note 2

The server apparatus according to supplementary note 1, wherein the ID linkage control means acquires, from the second service provider, biometric information of a second user and a second individual ID used by a second service provider for managing the second user, adds a new entry, in a case where matching processing using the acquired biometric information of the second user and the biometric information stored in the database fails, to the database, and stores the biometric information of the second user and the second individual ID in association with each other in the added entry.

### Supplementary Note 3

The server apparatus according to supplementary note 2, wherein each of the plurality of service providers store the individual ID of a registered user in association with a behavior history, and further including a behavior history control means that acquires, from each of the plurality of service providers, the behavior history corresponding to the individual ID by transmitting, to each of the plurality of service providers, the individual ID used by each service provider for managing the user, and provides externally an integrated behavior history in which the acquired behavior histories are integrated.

### Supplementary Note 4

The server apparatus according to supplementary note 3, wherein the behavior history control means acquires from each of the plurality of service providers, by transmitting to each of the plurality of service providers the individual ID used by each service provider for managing the user and attribute information specifying a user to be targeted for generation of the behavior histories, the behavior histories corresponding to the individual IDs of the specified user.

### Supplementary Note 5

The server apparatus according to supplementary note 2, wherein
the storage means stores, for the plurality of users, the biometric information and the individual IDs, the individual IDs being IDs for each of the plurality of service providers each of which provide services using the biometric authentication, and attribute information in the database in association with each other, and
further including a behavior history control means that extracts, from among the plurality of users, a user to be targeted for generation of a behavior history based on the attribute information, acquires, from each of the plurality of service providers, the behavior history of the user corresponding to the individual ID by transmitting to each service provider the individual ID used by the service provider for managing the extracted user, and provides externally an integrated behavior history in which the acquired behavior histories are integrated.

### Supplementary Note 6

The server apparatus according to supplementary note 2, wherein
the ID linkage control means receives, from a service provider that has succeeded in the biometric authentication of a person to be authenticated, an authentication success notification including the individual ID and a behavior history of the person to be authenticated whose the biometric authentication has succeeded, and stores, in an entry of the database corresponding to the individual ID included in the authentication success notification, the behavior history included in the authentication success notification.

### Supplementary Note 7

The server apparatus according to supplementary note 2, wherein
the ID linkage control means receives, from a service provider that has succeeded in the biometric authentication of a person to be authenticated, an authentication success notification including the individual ID and an authentication history of the person to be authenticated whose the biometric authentication has succeeded, and stores, in an entry of the database corresponding to the individual ID included in the authentication success notification, the authentication history included in the authentication success notification.

### Supplementary Note 8

A control method of a server apparatus, the control method including:
a storage step that stores, for a plurality of users, biometric information and individual IDs, the individual IDs being IDs for each of a plurality of service providers each of which provide services using biometric authentication, in a database in association with each other; and
an ID linkage control step that acquires, from a first service provider, biometric information of a first user and a first individual ID used by the first service provider for managing the first user, and stores, in a case where matching processing using the acquired biometric information of the first user and the biometric information stored in the database succeeds, the biometric information of the first user and the first individual ID in association with each other in an entry of the database identified by the matching processing.

### Supplementary Note 9

The control method of the server apparatus according to supplementary note 7, wherein
the ID linkage control step acquires, from the second service provider, biometric information of a second user and a second individual ID used by a second service provider for managing the second user, adds a new entry, in a case where matching processing using the acquired biometric information of the second user and the biometric information stored in the database fails, to the database, and stores the biometric information of the second user and the second individual ID in association with each other in the added entry.

### Supplementary Note 10

The control method of the server apparatus according to supplementary note 9, wherein
each of the plurality of service providers store the individual ID of a registered user in association with a behavior history, and
further including a behavior history control step that acquires, from each of the plurality of service providers, the behavior history corresponding to the individual ID by transmitting, to each of the plurality of service providers, the individual ID used by each service provider for managing the user, and provides externally an integrated behavior history in which the acquired behavior histories are integrated.

### Supplementary Note 11

The control method of the server apparatus according to supplementary note 10, wherein
the behavior history control step acquires from each of the plurality of service providers, by transmitting to each of the plurality of service providers the individual ID used by each service provider for managing the user and attribute information specifying a user to be targeted for generation of the behavior histories, the behavior histories corresponding to the individual IDs of the specified user.

### Supplementary Note 12

The control method of the server apparatus according to supplementary note 9, wherein
the storage step stores, for the plurality of users, the biometric information and the individual IDs, the individual IDs being IDs for each of the plurality of service providers each of which provide services using the biometric authentication, and attribute information in the database in association with each other, and
further including a behavior history control step that extracts, from among the plurality of users, a user to be targeted for generation of a behavior history based on the attribute information, acquires, from each of the plurality of service providers, the behavior history of the user corresponding to the individual ID by transmitting to each service provider the individual ID used by the service provider for managing the extracted user, and provides externally an integrated behavior history in which the acquired behavior histories are integrated.

### Supplementary Note 13

The control method of the server apparatus according to supplementary note 9, wherein
the ID linkage control step receives, from a service provider that has succeeded in the biometric authentication of a person to be authenticated, an authentication success notification including the individual ID and a behavior history of the person to be authenticated whose the biometric authentication has succeeded, and stores, in an entry of the database corresponding to the individual ID included in the authentication success notification, the behavior history included in the authentication success notification.

### Supplementary Note 14

The control method of the server apparatus according to supplementary note 9, wherein
the ID linkage control step receives, from a service provider that has succeeded in the biometric authentication of a person to be authenticated, an authentication success notification including the individual ID and an authentication history of the person to be authenticated whose the biometric authentication has succeeded, and stores, in an entry of the database corresponding to the individual ID included in the authentication success notification, the authentication history included in the authentication success notification.

### Supplementary Note 15

A computer-readable storage medium storing a program causing a computer mounted on a server apparatus to perform processing for:
a storage processing that stores, for a plurality of users, biometric information and individual IDs, the individual IDs being IDs for each of a plurality of service providers each of which provide services using biometric authentication, in a database in association with each other; and
an ID linkage control processing that acquires, from a first service provider, biometric information of a first user and a first individual ID used by the first service provider for managing the first user, and stores, in a case where matching processing using the acquired biometric information of the first user and the biometric information stored in the database succeeds, the biometric information of the first user and the first individual ID in association with each other in an entry of the database identified by the matching processing.

### Supplementary Note 16

The storage medium according to supplementary note 15, wherein
the ID linkage control processing acquires, from the second service provider, biometric information of a second user and a second individual ID used by a second service provider for managing the second user, adds a new entry, in a case where matching processing using the acquired biometric information of the second user and the biometric information stored in the database fails, to the database, and stores the biometric information of the second user and the second individual ID in association with each other in the added entry.

### Supplementary Note 17

The storage medium according to supplementary note 16, wherein
each of the plurality of service providers store the individual ID of a registered user in association with a behavior history, and
further performing a behavior history control processing that acquires, from each of the plurality of service providers, the behavior history corresponding to the individual ID by transmitting, to each of the plurality of service providers, the individual ID used by each service provider for managing the user, and provides externally an integrated behavior history in which the acquired behavior histories are integrated.

### Supplementary Note 18

The storage medium according to supplementary note 17, wherein
the behavior history control processing acquires from each of the plurality of service providers, by transmitting to each of the plurality of service providers the individual ID used by each service provider for managing the user and attribute information specifying a user to be targeted for generation of the behavior histories, the behavior histories corresponding to the individual IDs of the specified user.

### Supplementary Note 19

The storage medium according to supplementary note 16, wherein
the storage processing stores, for the plurality of users, the biometric information and the individual IDs, the individual IDs being IDs for each of the plurality of service providers each of which provide services using the biometric authentication, and attribute information in the database in association with each other, and
further performing a behavior history control processing that extracts, from among the plurality of users, a user to be targeted for generation of a behavior history based on the attribute information, acquires, from each of the plurality of service providers, the behavior history of the user corresponding to the individual ID by transmitting to each service provider the individual ID used by the service provider for managing the extracted user, and provides externally an integrated behavior history in which the acquired behavior histories are integrated.

### Supplementary Note 20

The storage medium according to supplementary note 16, wherein
the ID linkage control processing receives, from a service provider that has succeeded in the biometric authentication of a person to be authenticated, an authentication success notification including the individual ID and a behavior history of the person to be authenticated whose the biometric authentication has succeeded, and stores, in an entry of the database corresponding to the individual ID included in the authentication success notification, the behavior history included in the authentication success notification.

### Supplementary Note 21

The storage medium according to supplementary note 16, wherein
the ID linkage control processing receives, from a service provider that has succeeded in the biometric authentication of a person to be authenticated, an authentication success notification including the individual ID and an authentication history of the person to be authenticated whose the biometric authentication has succeeded, and stores, in an entry of the database corresponding to the individual ID included in the authentication success notification, the authentication history included in the authentication success notification.

The entire disclosure of the above patent literature is incorporated herein by reference thereto. While the example embodiments of the present invention have thus been described, the present invention is not limited to these example embodiments. It is to be understood to those skilled in the art that these example embodiments are only examples and that various variations are possible without departing from the scope and spirit of the present invention. That is, the present invention of course includes various variations and modifications that could be made by those skilled in the art in accordance with the overall disclosure including the claims and the technical concept.

### REFERENCE SIGNS LIST

10 control server
20 service server
30 authentication terminal
40 terminal
100 server apparatus
101 storage means
102 ID linkage control means
201 communication control unit
202 ID linkage control unit
203 behavior history control unit
204 storage unit
301 communication control unit
302 user registration unit
303 authentication control unit
304 storage unit
311 processor
312 memory
313 input-output interface
314 communication interface
401 communication control unit
402 provided service control unit
403 authentication request unit
404 storage unit

What is claimed is:

1. A server apparatus comprising:
at least one memory storing a set of instructions; and
at least one processor configured to execute the set of instructions to:
store, for a plurality of users, biometric information and individual IDs, the individual IDs being IDs for each of a plurality of service providers each of which provide services using biometric authentication, in a database in association with each other; and
acquire, from a first service provider, biometric information of a first user and a first individual ID used by the first service provider for managing the first user; and
store, in a case where matching processing using the acquired biometric information of the first user and the biometric information stored in the database succeeds, the biometric information of the first user and the first individual ID in association with each other in an entry of the database identified by the matching processing.

2. The server apparatus according to claim 1, wherein
the at least one processor is further configured to execute the set of instructions to:
acquire, from the second service provider, biometric information of a second user and a second individual ID used by a second service provider for managing the second user;
add a new entry, in a case where matching processing using the acquired biometric information of the second user and the biometric information stored in the database fails, to the database; and
store the biometric information of the second user and the second individual ID in association with each other in the added entry.

3. The server apparatus according to claim 2, wherein
each of the plurality of service providers store the individual ID of a registered user in association with a behavior history, and wherein
the at least one processor is further configured to execute the set of instructions to:
acquire, from each of the plurality of service providers, the behavior history corresponding to the individual ID by transmitting, to each of the plurality of service providers, the individual ID used by each service provider for managing the user; and
provide externally an integrated behavior history in which the acquired behavior histories are integrated.

4. The server apparatus according to claim 3, wherein
the at least one processor is further configured to execute the set of instructions to acquire from each of the plurality of service providers, by transmitting to each of the plurality of service providers the individual ID used by each service provider for managing the user and attribute information specifying a user to be targeted for generation of the behavior histories, the behavior histories corresponding to the individual IDs of the specified user.

5. The server apparatus according to claim 2, wherein
the at least one processor is further configured to execute the set of instructions to:
store, for the plurality of users, the biometric information and the individual IDs, the individual IDs being IDs for each of the plurality of service providers each of which provide services using the biometric authentication, and attribute information in the database in association with each other;
extract, from among the plurality of users, a user to be targeted for generation of a behavior history based on the attribute information,
acquire, from each of the plurality of service providers, the behavior history of the user corresponding to the individual ID by transmitting to each service provider the individual ID used by the service provider for managing the extracted user; and
provide externally an integrated behavior history in which the acquired behavior histories are integrated.

6. The server apparatus according to claim 2, wherein
the at least one processor is further configured to execute the set of instructions to:
receive, from a service provider that has succeeded in the biometric authentication of a person to be authenticated, an authentication success notification including the individual ID and a behavior history of the person to be authenticated whose the biometric authentication has succeeded; and
store, in an entry of the database corresponding to the individual ID included in the authentication success notification, the behavior history included in the authentication success notification.

7. The server apparatus according to claim 2, wherein
the at least one processor is further configured to execute the set of instructions to:
receive, from a service provider that has succeeded in the biometric authentication of a person to be authenticated, an authentication success notification including the individual ID and an authentication history of the person to be authenticated whose the biometric authentication has succeeded; and
store, in an entry of the database corresponding to the individual ID included in the authentication success notification, the authentication history included in the authentication success notification.

8. A control method of a server apparatus, the control method comprising:
storing, for a plurality of users, biometric information and individual IDs, the individual IDs being IDs for each of a plurality of service providers each of which provide services using biometric authentication, in a database in association with each other; and
acquiring, from a first service provider, biometric information of a first user and a first individual ID used by the first service provider for managing the first user; and
storing, in a case where matching processing using the acquired biometric information of the first user and the biometric information stored in the database succeeds, the biometric information of the first user and the first individual ID in association with each other in an entry of the database identified by the matching processing.

9. A non-transitory computer-readable storage medium storing a program causing a computer mounted on a server apparatus to perform processing for:
storing, for a plurality of users, biometric information and individual IDs, the individual IDs being IDs for each of a plurality of service providers each of which provide services using biometric authentication, in a database in association with each other; and
acquiring, from a first service provider, biometric information of a first user and a first individual ID used by the first service provider for managing the first user; and
storing, in a case where matching processing using the acquired biometric information of the first user and the biometric information stored in the database succeeds, the biometric information of the first user and the first individual ID in association with each other in an entry of the database identified by the matching processing.
